(19) United States
(12) Patent Application Publication
(10) Pub. No.: US 2008/0217819 A1
(43) Pub. Date: Sep. 11, 2008

(54) Micro/Nano-Pattern Film Contact Transfer Process

(75) Inventors: Yung-Chun Lee, Tainan City (TW); Chuan-Pu Liu, Tainan City (TW); Fei-Bin Hsiao, Tainan City (TW); Chun-Hung Chen, Yonghe City (TW); Cheng-Yu Chiu, Zhongli City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: NATIONAL CHENG KUNG UNIVERSITY, Tainan City (TW)

(21) Appl. No.: 11/779,997

(22) Filed: Jul. 19, 2007

(30) Foreign Application Priority Data
Jul. 20, 2006 (TW) 95126597

(51) Int. Cl. B29C 59/16

(52) U.S. Cl. 264/446

(57) ABSTRACT

A micro/nano-pattern film contact transfer process is described, comprising: providing a mold, wherein an imprinting pattern is set in a first surface of the mold; forming a release layer on the first surface of the mold and a transfer material layer on the release layer; providing a substrate; placing the mold on a first surface of the substrate, wherein the first surface of the mold is opposite to the first surface of the substrate; applying a pre-pressed force on the substrate from a second surface opposite to the first surface of the substrate; providing a heating source to heat the transfer material layer to produce an adhesion effect between a portion of the transfer material layer contacting with the first surface of the substrate and the substrate; and removing the mold, wherein the contacting portion of the transfer material layer is transferred onto the first surface of the substrate.

### RELATED APPLICATIONS

This application claims priority to Taiwan Application Serial Number 95126597, filed Jul. 20, 2006, which is herein incorporated by reference.

### FIELD OF THE INVENTION

The present invention relates to an imprinting process, and more particularly, to a micro/nano-pattern film contact transfer process.

### BACKGROUND OF THE INVENTION

Currently, the common imprinting techniques mainly include a hot embossing technique and a flexible nano-transferring technique. In the hot embossing technique, a substrate or a material coated on the substrate is heated by electrical resistance heating, and then a surface including an imprinting pattern of a mold is pressed into the substrate or the material on the substrate to make the imprinting pattern transfer into the substrate or the material on the substrate. In the flexible nano-transferring technique, a mold may be composed of a flexible polymer material, such as PDMS, next a self-assembly monomer is coated on a surface of the mold including an imprinting pattern, and then the mold contacts with the substrate to make the self-assembly monomer disposed on protruding portions of the surface of the mold transfer onto the substrate. The substrate is typically plated with a metal film, such as an Au film, and a strong bond is easily formed between the metal film and the self-assembly monomer, thereby making the self-assembly monomer form a nano-pattern on the metal film.

However, the hot embossing technique and a flexible nano-transferring technique respectively have some disadvantages. With regard to the hot embossing technique, a polymer material has to be used as a mask layer after transferring, and the residual layer after imprinting needs to be removed, so that the pattern is easily distorted or damaged during the removal process of the residual layer. In addition, it needs to cost dozens of minutes to heat the polymer material on the substrate from the room temperature to the temperature above the glass transition temperature and then to cool down the temperature of the polymer material to the room temperature, so that the rise and the decrease of the temperature both are time-consuming, which is very unfavorable to mass production.

As regard to the flexible nano-transferring technique, when the self-assembly monomer is printed onto the metal film, the self-assembly monomer spreads like ink, so that the resolution and the accuracy of the pattern transferring are degraded. In addition, the polymer material, such as PDMS, is a flexible material, so that it is difficult to control the size of the feature pattern.

### SUMMARY OF THE INVENTION

In view of the disadvantages of the conventional pattern transferring techniques, the present invention provides a micro/nano-pattern film contact transfer technique to replace the conventional hot embossing technique and the flexible nano-transferring technique to overcome the various disadvantages existing in the aforementioned prior arts.

One aspect of the present invention is to provide a micro/nano-pattern film contact transfer process, which can directly transfer a transfer material onto a substrate, so that the prior arts including using a polymer material to form an etching mask and using the polymer etching mask to perform the sequential etching process can be omitted.

Another aspect of the present invention is to provide a micro/nano-pattern film contact transfer process, in which a transferring process can be performed by a very small pressure, so that the life of the mold is prolonged.

Still another aspect of the present invention is to provide a micro/nano-pattern film contact transfer process, in which a non-flexible mold can be used to perform the transferring of a micro/nano-pattern film, so that the issue of being difficult to control the size of the feature pattern of the flexible material can be overcome.

Further another aspect of the present invention is to provide a micro/nano-pattern film contact transfer process, in which a surface modification step is performed on a pattern surface of a mold to make the pattern surface have a mold-releasing effect, so that the ability of successfully transferring the transfer layer contacting with the substrate to the substrate after contacting, heating and pressing is enhanced, thereby successfully forming the desired transferring pattern.

Yet another aspect of the present invention is to provide a micro/nano-pattern film contact transfer process, in which a mold can be composed of a silicon material, so that the manufacturing process of the mold is easy, the mold is cheap, and the selectivity of the mold material is various. Accordingly, various tiny patterns can be formed depending on the selection of the materials and the lattice characteristics of the materials, so that the desired structure can be easily formed on the mold, thereby increasing the variety of the nano-imprinting technique.

Yet another aspect of the present invention is to provide a micro/nano-pattern film contact transfer process, the material of the mold is various, and the mold can be composed of an organic material or an inorganic material.

According to the aforementioned aspects, the present invention provides a micro/nano-pattern film contact transfer process, comprising: providing a mold including a first surface and a second surface on opposite sides, and an imprinting pattern is set in the first surface of the mold; forming a release layer on the first surface of the mold; forming a transfer material layer on a surface of the release layer; providing a substrate including a first surface and a second surface on opposite sides; putting the mold together with the substrate to make the first surface of the mold be opposite to the first surface of the substrate; applying a pressure to make the first surface of the substrate closely contact with the transfer material layer on the first surface of the substrate, wherein the pressure is a uniform pressure or a concentrated pressure, when the step of applying the pressure is performed by applying the concentrated pressure, the pressure is continuously applied through a transparent cylinder, and the transparent cylinder can provide the heating source with a focus effect; providing a heating source to heat the transfer material layer, so as to produce an adhesion effect between a portion of the transfer material layer contacting with the first surface of the substrate and the first surface of the substrate; and removing the mold, wherein the contacting portion of the transfer material layer is transferred onto the first surface of the substrate.

According to a preferred embodiment of the present invention, the step of forming the release layer is performed by a coating method, a printing method, a physical deposition method, a chemical deposition method, an ion implantation method, or a plasma chemical deposition method. In addition, the transfer material layer is a metal layer.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIGS. 1 through 10 are schematic flow diagrams showing micro/nano-pattern film contact transfer processes in accordance with preferred embodiments of the present invention; and

FIGS. 11A and 11B are photographs of a transferring result of a micro/nano-pattern film contact transfer process in accordance with a preferred embodiment of the present invention.

### DETAILED DESCRIPTION OF THE PREFERRED EMBODIMENT

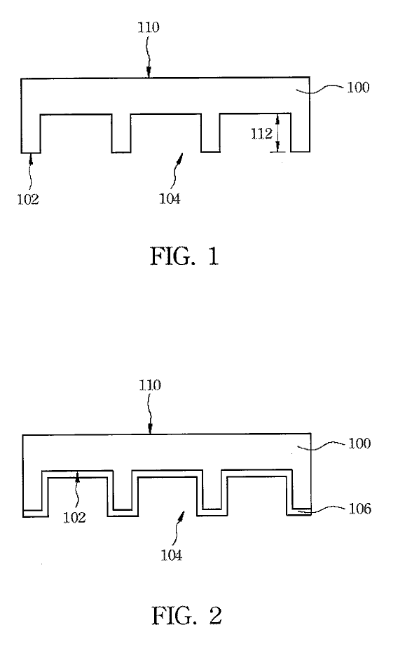

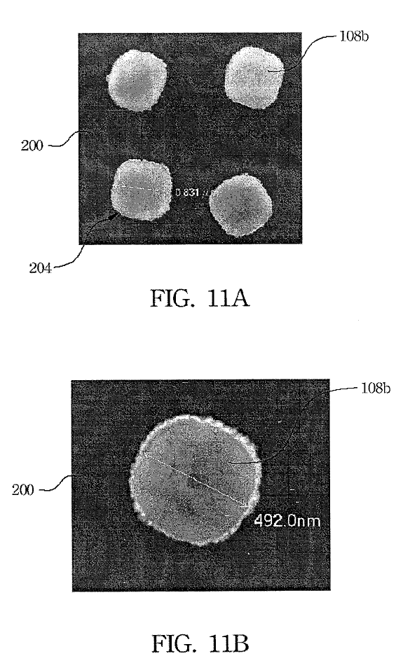

The present invention discloses a micro/nano-pattern film contact transfer process, which can directly transfer a transfer material onto a substrate, so that it is unnecessary to use a polymer material to form an etching mask in the sequential etching process, a pattern required by a nano-device can be directly defined and arrayed on the substrate, the transfer material is more various, and the problem of being difficult to control the size of a feature pattern of a flexible material can be solved. Accordingly, the transferring technique can achieve a large-area objective and advantages including low cost, rapid and mass production. In order to make the illustration of the present invention more explicit, the following description is stated with reference to FIGS. 1 through 11B.

FIGS. 1 through 10 are schematic flow diagrams showing micro/nano-pattern film contact transfer processes in accordance with preferred embodiments of the present invention. In an exemplary embodiment, when a micro/nano-pattern film contact transfer process is performed, a mold 100 is provided, wherein the mold 100 has surfaces 102 and 110 on opposite sides, and the surface 102 of the mold 100 is pre-set with an imprinting pattern 104, such as shown in FIG. 1. The material of the mold 100 has to be more refractory than the material desired to be transferred, wherein the mold 100 may be completely pervious to, partly pervious to or opaque to a heating source, such as a laser and a lamp source. In the exemplary embodiment, when the mold 100 is composed of a material that can be completely pervious to the heating source, such as a laser and a lamp source, the mold 100 cannot be heated, and the material of the mold 100 may be quartz; and when the 100 is composed of a material that can be partly pervious to or opaque to a heating source, such as a laser and a lamp source, the mold 100 can be heated, and the mold 100 may be composed of a silicon wafer. The material of the mold 100 may be a polymer group material, an organic material, a plastic material, a semiconductor material, a metal material, quartz, a glass material, a ceramic material, an inorganic material, an electric conduction material, or a compound material composed of two or more of the aforementioned materials.

In an embodiment of the present invention, in the process of setting the imprinting pattern 104 in the surface 102 of the mold 100, a polymer material layer (not shown) is formed on the surface 102 of the mold 100 by a coating method, a printing method, a physical deposition method, or a chemical deposition method, wherein a material of the polymer material layer may be acrylic or photoresist material. Next, a pattern definition step is performed on the polymer material layer by a common photo-lithography technique, an e-beam lithography technique, or a focus ion beam lithography technique, so as to define a pattern in the polymer material layer. Then, the mold 100 is etched by using the defined polymer material layer as the mask and using a dry etching method or a wet etching method, or by using a physical deposition method or a chemical deposition method combining with a lift off method, to define the desired imprinting pattern 104 into the surface 102 of the mold 100 to form the structure such as shown in FIG. 1. In the present exemplary embodiment, the size of the imprinting pattern 104 may be in micrometer or nanometer, or the size of the imprinting pattern 104 may be larger or smaller. In a preferred embodiment, the mold 100 further includes a plurality of alignment marks for the benefit of alignment in the sequential imprinting step.

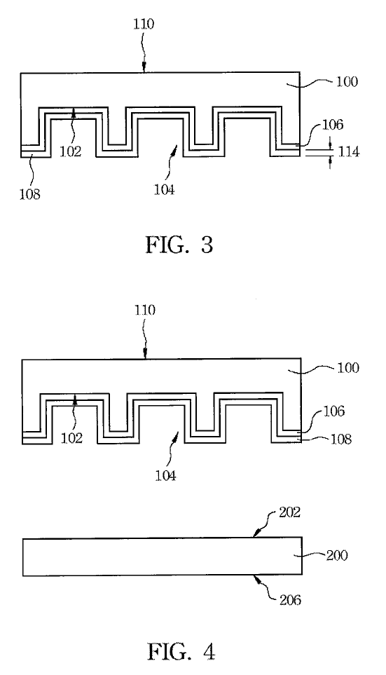

Then, referring to FIG. 2, a modification treatment is performed on the surface 102 including the imprinting pattern 104 of the mold 100, in which a release layer 106 may be formed on the surface 102 of the mold 100 by, for example, a coating method, a printing method, a physical deposition method, a chemical deposition method, an ion implantation method, or a plasma chemical deposition method. With the release layer 106, a transfer material layer 108 can easily come off the mold 100 and be transferred onto a substrate 200 shown in FIG. 4. The material of the release layer 106 may be an organic material, an inorganic material, a polymer material, a ceramic material, a metal material, a Teflon material, a diamond-like carbon material, a material formed by using plasma to dissociate CₓF_{y} compounds and then depositing the dissociated elements on the substrate 200, or a compound material composed of two or more of the aforementioned materials.

Next, referring to FIG. 3, a transfer material layer 108 is formed on the release layer 106 by, for example, a coating method, a printing method, a physical deposition method, or a chemical deposition method. The fusion point of the transfer material layer 108 is preferably lower than a fusion point of the mold 100. In addition, a glass transition temperature of the transfer material layer 108 is lower than a fusion point of the mold 100. The transfer material layer 108 may be formed by stacking two or more layers consisting of the same material or different materials. In the exemplary embodiment of the present invention, the transfer material layer 108 may be a semiconductor material, a ceramic material, an organic material, a plastic material, a polymer material, an electric conduction material, an inorganic material, a metal material, or a compound material composed of two or more of the aforementioned materials.

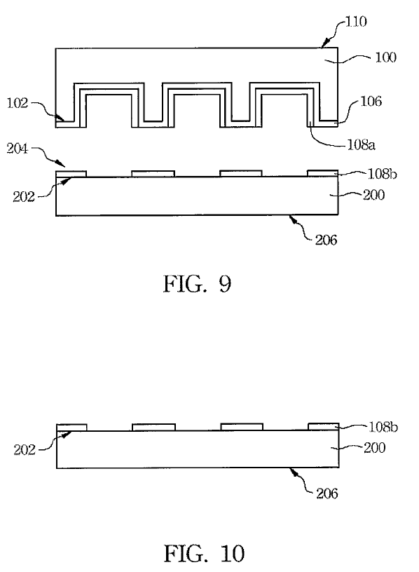

The release layer 106 is formed on the surface 102 including the imprinting pattern 104 of the mold 100, so that the adhesion between the transfer material layer 108 and the surface 102 of the mold 100 can be eliminated, and the transfer material layer 108 can be successfully transferred from the surface 102 of the mold 100 onto the surface 202 of the substrate 200 (referring to FIG. 9).

Next, referring to FIG. 4, the substrate 200 including surfaces 202 and 206 on opposite sides is provided, wherein a material of the substrate 200 may be a semiconductor material, a metal material, quartz, a glass material, a ceramic material, an organic material, a plastic material, a polymer material, an electric conduction material, an inorganic material, or a compound material composed of two or more of the aforementioned materials. In a preferred embodiment of the present invention, the material of the substrate 200 is silicon. In another preferred embodiment of the present invention, the substrate 200 is set with a plurality of alignment marks for the benefit of alignment between the mold 100 and the substrate 200 during the sequential imprinting process.

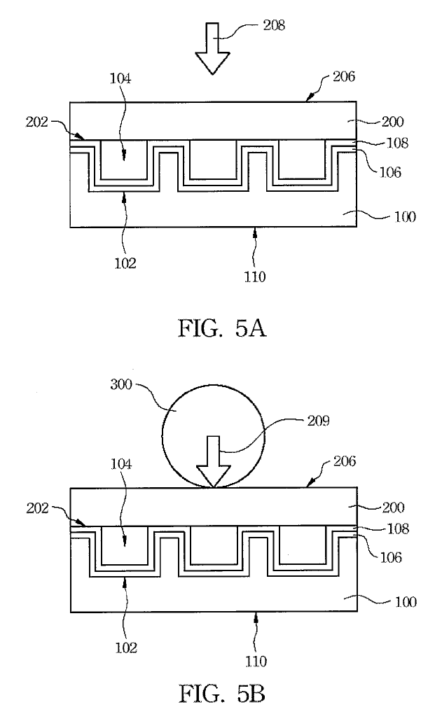

Then, the mold 100 is put together with the substrate 200 to make the surface 102 of the mold 100 be opposite to the surface 202 of the substrate 200. When the mold 100 is put together with the substrate 200, the alignment marks on the substrate 200 and the mold 100 may be used to ensure the relative location during the imprinting of the substrate 200 and the mold 100. In addition, when the mold 100 is put together with the substrate 200, a pre-pressed force is selectively applied to slightly fix the relative location of the mold 100 and the substrate 200. Then, a pressure is applied on a surface 206 of the substrate 200 opposite to the surface 202, wherein the pressure may be applied by a uniform pressure 208 (FIG. 5A) or a concentrated pressure 209 (FIG. 5B). The concentrated pressure 209 may be applied through a transparent cylinder 300 to apply the pressure 209 continuously, such as shown in FIG. 5B. The material of the transparent cylinder 300 is depending on the light wavelength of the heating source, i.e. the transparent cylinder 300 is preferably pervious to the light emitted from the heating source. In an embodiment, a material of the transparent cylinder 300 is a polymer group material, an organic material, a plastic material, a semiconductor material, a metal material, quartz, a glass material, a ceramic material, an inorganic material, an electric conduction material, or a compound material composed of two or more of the aforementioned materials. The transparent cylinder 300 can provide a heating source with a focus effect. The applied pressure 208 or 209 can make the mold 100 contact with the substrate 200 closely, such as shown in FIGS. 5A and 5B. The pressure 208 or 209 is applied by, for example, a mechanical method, an electromagnetic method, a hydraulic pressure method or an atmospheric pressure method.

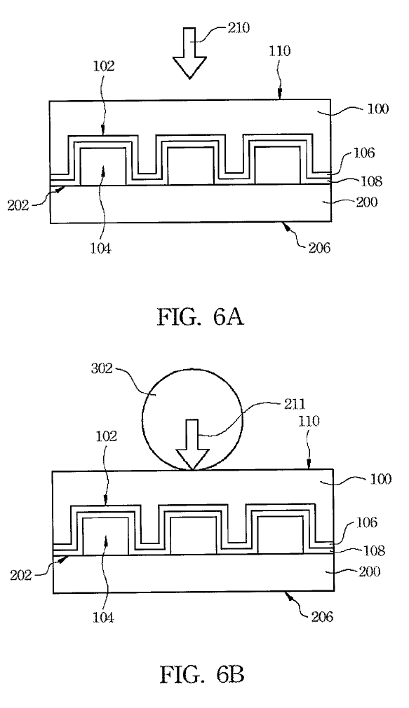

In another embodiment of the present invention, when the mold 100 is put together with the substrate 200, a pre-pressed force is selectively applied to slightly fix the relative location of the mold 100 and the substrate 200. Next, a pressure is applied on the surface 110 of the mold 100 opposite to the surface 102 to make the mold 100 contact with the substrate 200 closely. Similarly, the pressure may be applied by a uniform pressure 210 or a concentrated pressure 211, such as shown in FIG. 6A or 6B. The concentrated pressure 211 may be applied through a transparent cylinder 302 to apply the pressure 211 continuously, such as shown in FIG. 6B. The transparent cylinder 302 also can provide a heating source with a focus effect. The material of the transparent cylinder 302 is the same as that of the transparent cylinder 300. The pressure 210 or 211 is applied by, for example, a mechanical method, an electromagnetic method, a hydraulic pressure method or an atmospheric pressure method.

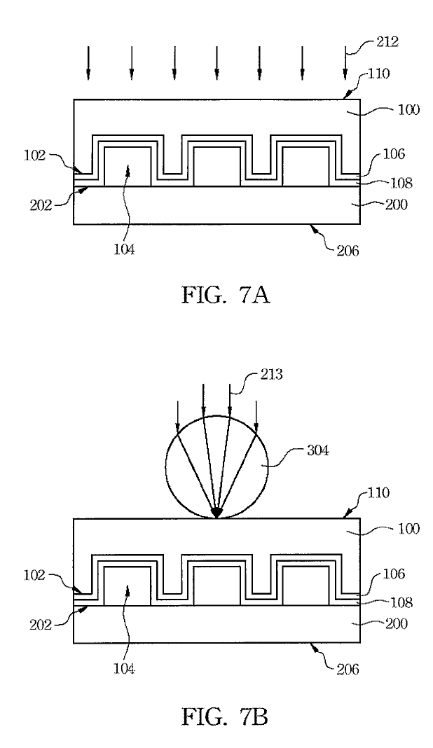

After the mold 100 closely contacts with the substrate 200, a heating source 212 emits a laser light or a light with an appropriate wavelength through the surface 110 of the mold 100 to the surface 102 of the mold 100 to heat the transfer material layer 108, such as shown in FIG. 7A. In another embodiment of the present invention, a heating source 213 emits a laser light or a light with an appropriate wavelength through a transparent cylinder 304 and then the surface 110 of the mold 100 to the surface 102, to heat the transfer material layer 108, wherein the transparent cylinder 304 can provide the heating source 213 with a focus effect, such as shown in FIG. 7B. The material of the transparent cylinder 304 is the same as that of the transparent cylinder 300. The heating source 212 or 213 may be a laser or a lamp, wherein a light wavelength of the laser is preferably between about 1 nm and about 10⁷ μm, and a light wavelength of the lamp is preferably between about 1 nm and about 10⁷ μM. In an embodiment of the present invention, the heating source 212 or 213 is a laser with a wavelength of about 1064 nm. In a preferred embodiment of the present embodiment, the heating source is an infrared-pulsed laser.

When the mold 100 is completely pervious to, partly pervious to and partly absorbed, or completely absorbed the laser light or the light with the appropriate wavelength, the transfer material layer 108 is heated in three different conditions to achieve the objective of transferring. In the first condition, when the laser light or the light completely passes through the mold 100 to heat the transfer material layer 108, the temperature of the transfer material layer 108 rises up to that an adhesion effect can be produced between the transfer material layer 108 and the surface 202 of the substrate 200 in a very short time, and the strength of the adhesion effect is larger than that between the release layer 106 formed on the surface 102 of the mold 100 and the transfer material layer 108. In the second condition, when the laser light or the light is completely absorbed by the mold 100, the mold 100 is heated in a very short time, and then the transfer material layer 108 is heated by a heat conduction phenomenon to make the temperature of the transfer material layer 108 rise up to that an adhesion effect can be produced between the transfer material layer 108 and the surface 202 of the substrate 200, wherein the strength of the adhesion effect is larger than that between the release layer 106 formed on the surface 102 of the mold 100 and the transfer material layer 108. In the third condition, when the laser light or the light is partly absorbed by the mold 100 and partly passes through the mold 100, the mold 100 and the transfer material layer 108 are heated simultaneously, so that a mix effect of the first condition and the second condition occurs to make an adhesion effect produce between the transfer material layer 108 and the surface 202 of the substrate 200, wherein the strength of the adhesion effect is larger than that between the release layer 106 formed on the surface 102 of the mold 100 and the transfer material layer 108.

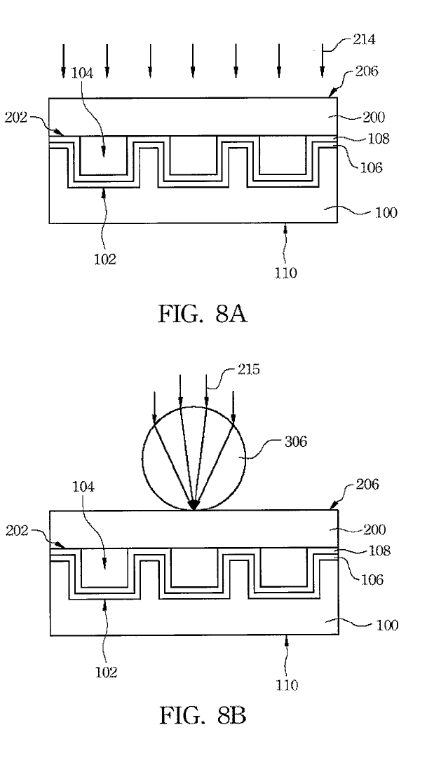

In the other embodiments of the present invention, a heating source 214 emits a laser light or a light with an appropriate wavelength through the surface 206 of the substrate 200 to the surface 202 of the substrate 200 to heat the transfer material layer 108, such as shown in FIG. 8A. In another embodiment of the present invention, a heating source 215 emits a laser light or a light with an appropriate wavelength through a transparent cylinder 306 and then the surface 206 of the substrate 200 to the surface 202, to heat the transfer material layer 108, wherein the transparent cylinder 306 can provide the heating source 215 with a focus effect, such as shown in FIG. 8B. The material of the transparent cylinder 306 is the same as that of the transparent cylinder 300. When the laser light or the light with the appropriate wavelength completely passes through the substrate 200, is partly absorbed by the substrate 200 and partly passes through the substrate 200, or is completely absorbed by the substrate 200, the transfer material layer 108 is heated in three different conditions to achieve the objective of transferring. In the first condition, when the laser light or the light completely passes through the substrate 200 to heat the transfer material layer 108, the temperature of the transfer material layer 108 rises up to that an adhesion effect can be produced between the transfer material layer 108 and the surface 202 of the substrate 200 in a very short time, and the strength of the adhesion effect is larger than that between the release layer 106 formed on the surface 102 of the mold 100 and the transfer material layer 108. In the second condition, when the laser light or the light is completely absorbed by the substrate 200, the substrate 200 is heated in a very short time, and then the transfer material layer 108 is heated by a heat conduction phenomenon to make the temperature of the transfer material layer 108 rise up to that an adhesion effect can be produced between the transfer material layer 108 and the surface 202 of the substrate 200, wherein the strength of the adhesion effect is larger than that between the release layer 106 formed on the surface 102 of the mold 100 and the transfer material layer 108. In the third condition, when the laser light or the light is partly absorbed by the substrate 200 and partly passes through the substrate 200, the substrate 200 and the transfer material layer 108 are heated simultaneously, so that a mix effect of the first condition and the second condition occurs to make an adhesion effect produce between the transfer material layer 108 and the surface 202 of the substrate 200, wherein the strength of the adhesion effect is larger than that between the release layer 106 formed on the surface 102 of the mold 100 and the transfer material layer 108.

Accordingly, one feature of the present invention is to perform a surface modification treatment on the surface of the mold to modify the adhesion strength between the mold and the transfer material layer, and is to use the light or the laser light to heat the transfer material layer under an appropriate pre-pressed force, so as to enhance the efficiency of transferring the transfer material layer onto the surface of the substrate.

After heating and pressing, an adhesion effect is produced between the transfer material layer 108 and the surface 202 of the substrate 200. Then, after the substrate 200 or the transfer material layer 108 on the substrate 200 is cooled down and is solidified, a mold-drawn action is performed to separate the mold 100 and the transfer material layer 108b that has the adhesion effect with the surface 202 of the substrate 200, so as to remain the transfer material layer 108a that does not have the adhesion effect with the surface 202 of the substrate 200 on the mold 100. For the time being, the imprinting pattern 104 on the mold 100 has been successfully transferred onto the surface 202 of the substrate 200 to form a pattern 204 composed of the transfer material layer 108b, such as shown in FIG. 9.

The transfer material layer 108b having been transferred on the surface 202 of the substrate 200 can be used as a mask in the sequential process of etching the substrate 200, such as shown in FIG. 10. When the substrate 200 needs to be etched in the sequential process, a desired pattern can be formed on the substrate 200 by a dry etching method or a wet etching method with the transfer material layer 108b being the etching mask, so as to complete the pattern transferring of the substrate 200. It is noteworthy that the imprinting step of the mold 100 in the present invention can be repeatedly applied on the same substrate 200 with the use of different transfer material layers 108.

In a preferred embodiment of the present invention, the material of the mold 100 is silicon, and the imprinting pattern defined in the surface of the mold 100 is a dot pattern. After the release layer 106 is evaporated, a chromium (Cr) metal layer as the transfer material layer 108 is evaporated on the release layer 106, wherein a depth 112 of the imprinting pattern 104 of the mold 100 (shown in FIG. 1) is about 300 nm, and the thickness of the chromium metal layer as the transfer material layer 108 (shown in FIG. 3) is about 100 μm. In the present exemplary embodiment, after imprinting, the imprinting result is shown in the photographs in FIGS. 1A and 1B, wherein the pattern 204 is composed of a plurality of dot transfer material layers 108b.

According to the aforementioned description, one advantage of the present invention is that a micro/nano-pattern film contact transfer process of the present invention performs a surface modification treatment on the pattern surface of the mold by forming a release layer, so that the adhesion between the mold and the transfer material layer can be greatly reduced. In addition, the adhesion between the transfer material layer and the substrate can be increased in a very short time by using a light or a laser light to heat the transfer material layer, so that the transfer material layer can be transfer onto the substrate by applying an appropriate pre-pressed force.

According to the aforementioned description, another advantage of the present invention is that a transfer material layer can be directly transferred onto a substrate, so that materials required by devices to be developed can be adopted as transfer materials to be directly transferred onto the substrate, and depositing the materials required by the devices to be developed by using a photoresist as a mask layer in the conventional method can be omitted. Accordingly, the process is simplified, the defective rate is reduced in the process, the process time is decreased, and the fabrication of the devices including nano-patterns set therein achieves the objectives of large area, rapid and mass production.

According to the aforementioned description, still another advantage of the present invention is that a mold of the present invention can be composed of a silicon material, so that the manufacturing process of the mold is easy, the mold is cheap, and the selectivity of the mold material is various. Accordingly, the mold can be easily formed with desired structures including various and three-dimensional patterns according to the change and the lattice characteristics of the materials, thereby increasing the variety of the nano-imprinting technique. Furthermore, in the present invention, when the mold is made from silicon, the fabrication of the mold is cheaper and easier, and the mold is easily applied to the current semiconductor process. Moreover, the present invention may be implemented by transferring a pattern onto a quartz material by an imprinting method to fabricate the quartz mold to connect with the prior techniques.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A micro/nano-pattern film contact transfer process, comprising:
providing a mold including a first surface and a second surface on opposite sides, and an imprinting pattern is set in the first surface of the mold;
forming a release layer on the first surface of the mold;
forming a transfer material layer on a surface of the release layer;
providing a substrate including a first surface and a second surface on opposite sides;
putting the mold together with the substrate to make the first surface of the mold be opposite to the first surface of the substrate;
applying a pressure to make the first surface of the substrate closely contact with the transfer material layer on the first surface of the substrate;
providing a heating source to heat the transfer material layer, so as to produce an adhesion effect between a portion of the transfer material layer contacting with the first surface of the substrate and the first surface of the substrate; and
removing the mold, wherein the contacting portion of the transfer material layer is transferred onto the first surface of the substrate.

2. The micro/nano-pattern film contact transfer process according to claim 1, wherein a material of the mold is silicon wafer, a polymer group material, an organic material, a plastic material, a semiconductor material, a metal material, quartz, a glass material, a ceramic material, an inorganic material, an electric conduction material, or a compound material composed of two or more of the aforementioned materials.

3. The micro/nano-pattern film contact transfer process according to claim 1, wherein the step of forming the release layer is performed by a coating method, a printing method, a physical deposition method, a chemical deposition method, an ion implantation method, or a plasma chemical deposition method.

4. The micro/nano-pattern film contact transfer process according to claim 1, wherein a material of the release layer is an organic material, an inorganic material, a polymer material, a ceramic material, a metal material, a Teflon material, a diamond-like carbon material, a material formed by using plasma to dissociate CₓF_{y} compounds and then depositing the dissociated elements on the substrate, or a compound material composed of two or more of the aforementioned materials.

5. The micro/nano-pattern film contact transfer process according to claim 1, wherein the transfer material layer is a metal layer or an alloy material layer.

6. The micro/nano-pattern film contact transfer process according to claim 1, wherein the step of forming the transfer material layer is performed by a coating method, a printing method, a physical deposition method, or a chemical deposition method.

7. The micro/nano-pattern film contact transfer process according to claim 1, wherein a material of the transfer material is a semiconductor material, a ceramic material, an organic material, a plastic material, a polymer material, an electric conduction material, an inorganic material, a metal material, or a compound material composed of two or more of the aforementioned materials.

8. The micro/nano-pattern film contact transfer process according to claim 1, wherein the transfer material layer is composed of two or more stacked layers consisting of the same material, or two or more stacked layers consisting of different materials.

9. The micro/nano-pattern film contact transfer process according to claim 1, wherein a material of the substrate is a semiconductor material, a metal material, quartz, a glass material, a ceramic material, an organic material, a plastic material, a polymer material, an electric conduction material, an inorganic material, or a compound material composed of two or more of the aforementioned materials.

10. The micro/nano-pattern film contact transfer process according to claim 1, wherein a material of the substrate is silicon.

11. The micro/nano-pattern film contact transfer process according to claim 1, wherein a fusion point of the transfer material layer is lower than a fusion point of the mold.

12. The micro/nano-pattern film contact transfer process according to claim 1, wherein a glass transition temperature of the transfer material layer is lower than a fusion point of the mold.

13. The micro/nano-pattern film contact transfer process according to claim 1, wherein the step of putting the mold together with the substrate further comprises applying a pre-pressed force from the second surface toward the first surface of the mold.

14. The micro/nano-pattern film contact transfer process according to claim 1, wherein the step of applying the pressure is performed by applying a uniform pressure or a concentrated pressure.

15. The micro/nano-pattern film contact transfer process according to claim 14, wherein when the step of applying the pressure is performed by applying the concentrated pressure, the pressure is applied through a transparent cylinder.

16. The micro/nano-pattern film contact transfer process according to claim 15, wherein a material of the transparent cylinder is a polymer group material, an organic material, a plastic material, a semiconductor material, a metal material, quartz, a glass material, a ceramic material, an inorganic material, an electric conduction material, or a compound material composed of two or more of the aforementioned materials.

17. The micro/nano-pattern film contact transfer process according to claim 1, wherein the heating source is a laser or a lamp, and a light wavelength of the heating source is between about 1 nm and about 10⁷ μm.

18. The micro/nano-pattern film contact transfer process according to claim 1, wherein the step of applying the pressure is performed by a mechanical method, an electromagnetic method, a hydraulic pressure method or an atmospheric pressure method.

19. The micro/nano-pattern film contact transfer process according to claim 1, wherein
in the step of applying the pressure, the pressure is applied from the second surface of the substrate toward the first surface of the substrate; and
in the step of providing the heating source, a light emitted by the heating source passes through the second surface of the mold to the first surface of the mold or a light emitted by the heating source passes through the second surface of the substrate to the first surface of the substrate.

20. The micro/nano-pattern film contact transfer process according to claim 1, wherein
in the step of applying the pressure, the pressure is applied from the second surface of the mold toward the first surface of the mold; and
in the step of providing the heating source, a light emitted by the heating source passes through the second surface of the substrate to the first surface of the substrate or a light emitted by the heating source passes through the second surface of the mold to the first surface of the mold.
